(19) United States
(12) Patent Application Publication
(10) Pub. No.: US 2007/0090658 A1
(43) Pub. Date: Apr. 26, 2007

(54) Hook-type bottom block

(76) Inventor: Uwe Frommelt, Ehingen (DE)

Correspondence Address: ALLEMAN HALL MCCOY RUSSELL & TUTTLE LLP, 806 SW BROADWAY, SUITE 600, PORTLAND, OR, 97205-3335, US

(21) Appl. No.: 11/584,342

(22) Filed: Oct. 20, 2006

(30) Foreign Application Priority Data
Oct. 25, 2005 (DE) 20 2005 016 742.8

(51) Int. Cl. B66C 1/34

(52) U.S. Cl. 294/82.15; 254/401

(57) ABSTRACT

The present disclosure relates to a hook-type bottom block for a crane, preferably a mobile crane, comprising a lower part to which the hook is fastened in a rotatable and tiltable manner and an upper part in which rollers are supported via which at least one hoist rope can be sheared in. In accordance with the present disclosure, the rollers are combined in a plurality of roller sets connectable to one another in a modular manner.

### CROSS REFERENCE TO RELATED APPLICATION

This application claims priority to German Utility Model Application No. 20 2005 016 742.8, filed Oct. 25, 2005, which is hereby incorporated by reference in its entirety for all purposes.

### FIELD

The present disclosure relates to a hook-type bottom block for a crane, preferably for a mobile crane.

### BACKGROUND AND SUMMARY

A hook-type bottom block is the connection between the hoist rope of a crane and the load. The hook-type bottom block has a lower part to which a correspondingly shaped hook is fastened in a rotatable and tiltable manner. Sheaves, which are called rollers in the following, are arranged on a shaft in the upper part connected to this lower part. The hoist rope is sheared in via the rollers in accordance with the block and pulley principle.

Depending on the task, hook-type bottom blocks with different roller sets have to be used. For this purpose, a number of different hook-type bottom blocks must be produced and kept in store.

It is the object of the present disclosure to minimize the production effort and the storage for hook-type bottom blocks.

This object is satisfied in accordance with the present disclosure in that, with a generic hook-type bottom block for a crane having a lower part to which the hook is fastened in a rotatable and tiltable manner and having an upper part in which the rollers are supported via which at least one hoist rope can be sheared in, the rollers are combined into a plurality of roller sets which can be connected to one another in the manner of modules. In accordance with the present disclosure, different bottom blocks can therefore be made up from the individual modules using the modular system principle. This increases the flexibility in use of the hook-type bottom block taken along since the individual modules of the hook-type bottom block can be combined differently with one another for different uses.

In one example, the rollers can be connected to the hook via a hook yoke.

Further, a pair having two respective roller sets of different roller numbers can be connected to one another here. The roller sets can each be bolted to one another. The different roller set constellations can thereby be put together very simply.

When the hook-type bottom block is made with a pair having two respective roller sets of different roller numbers, two hoist ropes can advantageously be sheared in by two winches, with the winches being able to be run in parallel operation and with the different running behavior of both winches, which cannot be avoided, being able to be compensated via the hook yoke. For this purpose, the individual roller sets combined with one another in each case are connected to one another in an oscillating manner via the hook yoke.

In a preferred embodiment of the present disclosure, only some of the roller sets can be connected to one another in a different combination. A plurality of hook-type bottom block constellations can thus be put together depending on use. The respective roller sets can be combined with one another for this purpose. Depending on the width and design of the roller sets, however, different hooks and hook yokes must be used.

### BRIEF DESCRIPTION OF FIGURES

Further features, details and advantages of the present disclosure will be explained in more detail with reference to embodiments shown in the drawings.

FIG. 1 shows a hook-type bottom block in accordance with an embodiment variant of the present disclosure in the fully set-up state;

FIG. 2 shows a combination of some of the roller sets in accordance with the hook-type bottom block in accordance with FIG. 1;

FIG. 3 shows a combination of some other roller sets in another stage of development of the hook-type bottom block in accordance with FIG. 1; and

FIGS. 4 and 5 show further stages of development of a hook-type bottom block in accordance with the embodiment variant shown in FIG. 1.

### DETAILED DESCRIPTION

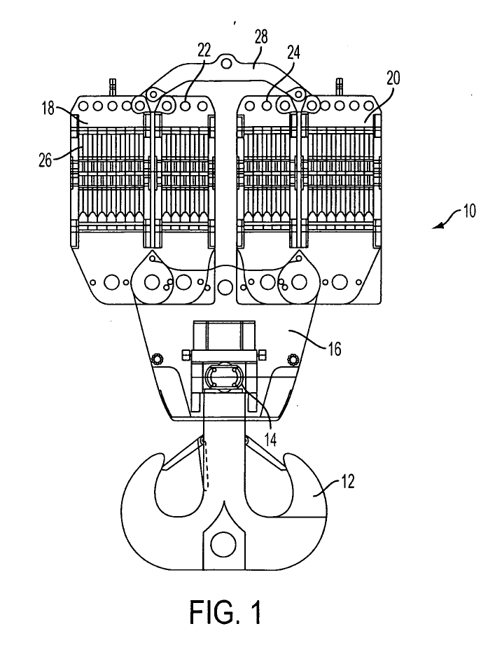

A hook-type bottom block 10 in the modular construction in accordance with the present disclosure is shown in FIG. 1. Here, a hook 12 is supported pivotably around a pivot bearing 14 in a hook yoke 16. The hook yoke 16 forms the lower part of the hook-type bottom block 10 together with the pivotably supported hook 12. The upper part of the hook-type bottom block 10 is formed by a plurality of roller sets 18, 20, 22 and 24 which can be connected to one another in the manner of a module. These roller sets can be connected to one another in a modular manner, with the connection here typically taking place via a bolt connection. In the embodiment shown here, the roller sets 18 and 20 or 22 and 24 respectively are provided with the same number of rollers. The roller sets 18 and 20 thus each have seven rollers 26, whereas the roller sets 22 and 24 each have five rollers 26. As shown in FIG. 1, the roller sets 18 and 22, on the one hand, and 20 and 24, on the other hand, are bolted to one another, with them each being bolted to the hook yoke 16 such that an oscillating movement is permitted. The two roller sets 18 and 22 or 20 and 24 respectively, which are combined together, are connected to one another via a hoop 28 at the side disposed opposite the hook yoke 16.

The different number of rollers 26 in the roller sets 18, 20, 22 and 24 generally make it possible to realize different hook-type bottom blocks 10. In the embodiment in accordance with FIG. 1, the hook-type bottom block 10 is set up such that two hoist ropes can be sheared in by two winches. This is necessary since a single hoist rope length would not be sufficient to lower the hook-type bottom block 10 onto the ground. This means that both winches (not shown here) are run in parallel operation. The different running behavior of the two winches is compensated via the hook yoke 16.

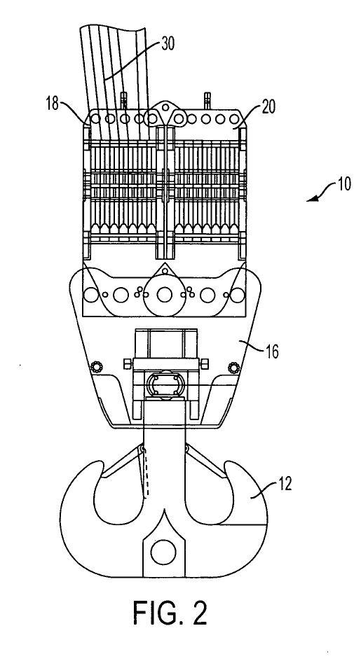

In FIG. 2, a different modular-type combination of the hook-type bottom block 10 is shown. Here, the roller sets 18 and 20 are coupled to one another such that they act as one single roller set. For this purpose, the roller sets 18 and 20 are rigidly coupled to one another. The lower part of the hook-type bottom block 10 consisting of the hook yoke 16 and the pivotable hook 12 is seated in a typical manner beneath this upper part of the hook-type bottom block 10 formed from the roller sets 18 and 20. This embodiment serves the shearing in with only one winch. The hoist ropes 30 are here shown on one side in the form of a so-called oblique pull at an angle of >4°.

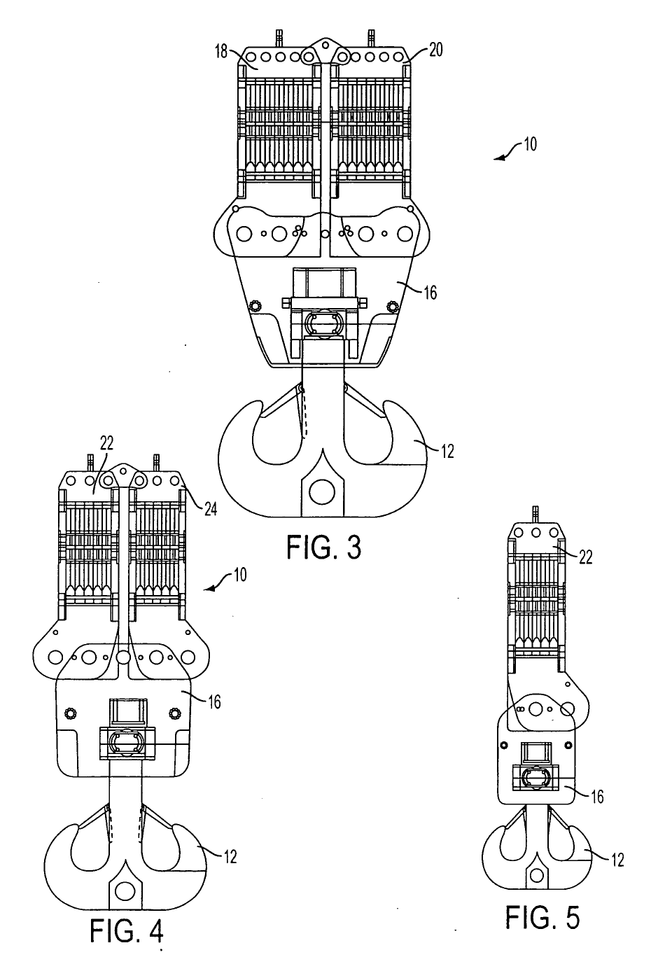

A further embodiment of the present disclosure which shows a hook-type bottom block 10 made up of the roller set modules 18 and 20 results from FIG. 3. There, the roller set modules are connected to one another in an oscillating manner so that in turn a rope length compensation can take place when here two hoist ropes, which run off via two winches, are sheared in.

In FIG. 4, an embodiment of the hook-type bottom block 10 is shown in which the two narrow roller sets 22 and 24 are used. They are bolted together in the manner shown here. A hook yoke 16 with hooks 12 can be bolted thereto. This hook-type bottom block 10 made up of the narrow roller sets 22 and 24 can be used, together with a hook-type bottom block such as was shown with reference to FIG. 2, with the hook-type bottom block 10 being used in accordance with FIG. 2 at a main boom tip of a mobile crane, whereas this hook-type bottom block shown in accordance with FIG. 4 is used as a second further hook-type bottom block at the luffing tip of a vehicle crane. In this installation case, a second hook 12 must admittedly be used, but the roller sets such as were originally provided in the stage of development of FIG. 1 and such as are optionally taken along can be connected to one another in a modular manner so that the two embodiments in accordance with FIG. 2 and FIG. 4 arise and can be used simultaneously in one mobile crane.

Finally, the embodiment in accordance with FIG. 5 shows the use of an individual narrow roller set 22 having a small hook 12 and a corresponding hook yoke 16.

The combination possibilities shown here for the hook-type bottom block set up in a modular manner are only shown by way of example. Any desired further combinations are possible.

1. A hook-type bottom block for a crane, comprising:
a lower part to which the hook is fastened in a rotatable and tiltable manner; and
an upper part in which rollers are supported via which at least one hoist rope can be sheared in, where the rollers are combined in a plurality of roller sets connectable to one another in a modular manner.

2. A hook-type bottom block in accordance with claim 1, wherein the roller sets are connected to the hook via a hook yoke.

3. A hook-type bottom block in accordance with claim 1, wherein a pair having two respective roller sets of different roller numbers is connected to one another.

4. A hook-type bottom block in accordance with claim 3, wherein the roller sets are boltable to one another in each case.

5. A hook-type bottom block in accordance with claim 4, wherein two hoist ropes can be sheared in from two winches, with the winches being able to run in parallel operation and with the different running behavior of both winches being able to be compensated via the hook yoke.

6. A hook-type bottom block in accordance with claim 5, where only some of the roller sets are connected to one another in a different combination.

7. A mobile crane system, comprising:
at least one hoist rope; and
a hook-type bottom block, comprising:
a lower part to which the hook is fastened in a rotatable and tiltable manner; and
an upper part in which rollers are supported, via which the at least one hoist rope can be sheared in, where the rollers are combined in a plurality of roller sets connectable to one another in a modular manner.

8. A mobile crane system accordance with claim 7, wherein the roller sets are connected to the hook via a hook yoke.

9. A mobile crane system accordance with claim 8, wherein a pair having two respective roller sets of different roller numbers is connected to one another.

10. A mobile crane system accordance with claim 9, wherein the roller sets are boltable to one another.

11. A mobile crane system accordance with claim 10 further comprising a second hoist rope, wherein both the first and second hoist ropes are sheared in via two winches, with the winches operable in parallel with different running behavior of both winches being compensated via the hook yoke.

12. A mobile crane system in accordance with claim 11, where only some of the roller sets are connected to one another in a different combination.

13. A method of configuring a hook-type bottom block for a crane, the block having a lower part to which the hook is fastened in a rotatable and tiltable manner and an upper part in which rollers are supported via which at least one hoist rope can be sheared in, where the rollers are combined in a plurality of roller sets, and the roller sets are each modularly connectable to one another, comprising:
combining a plurality of individual modules of the hook-type bottom block to configure the bottom block;
varying the combination of modules to provide different bottom blocks; and
using the bottom block for different applications depending on the combination.

14. The method of claim 13 wherein the roller sets are connected to the hook via a hook yoke and wherein the block includes a pair having two respective roller sets of different roller numbers connected to one another, the roller sets boltable to one another in each case, the method further comprising:
shearing two hoist ropes in from two winches, with the winches being run in parallel operation; and
compensating for the different running behavior of both winches via a hook yoke.
